(19) United States
(12) Patent Application Publication
(10) Pub. No.: US 2012/0173448 A1
(43) Pub. Date: Jul. 5, 2012

(54) SYSTEMS AND METHODS FOR PROVIDING DELIVERY FLEXIBILITY AND COMMUNICATION

(76) Inventor: William B. Rademaker, Seattle, WA (US)

(21) Appl. No.: 13/290,039

(22) Filed: Nov. 4, 2011

Related U.S. Application Data
(60) Provisional application No. 61/467,654, filed on Mar. 25, 2011.
(60) Provisional application No. 61/438,937, filed on Feb. 2, 2011.
(60) Provisional application No. 61/410,312, filed on Nov. 4, 2010.

(51) Int. Cl. G06Q 50/28

(52) U.S. Cl. 705/338

(57) ABSTRACT

Methods and systems for managing delivery of a package from a sender to a receiver are provided. In some embodiments, the package is transported from the sender to the receiver by one or more custodians. While the package is en route, one or more intermediate custodians may be added to the chain of custody of the package. A current custodian may be directed to an intermediate custodian instead of to the receiver. A handoff from the current custodian to the intermediate custodian may be tracked and verified, and the intermediate custodian may then be directed to the receiver or to another intermediate custodian. In some embodiments, a secure communication channel is established between the receiver and current and/or future custodians in the chain of custody.

### CROSS-REFERENCES TO RELATED APPLICATIONS

This application claims the benefit of Provisional Application No. 61/467654, filed Mar. 25, 2011; Provisional Application No. 61/438937, filed Feb. 2, 2011; and Provisional Application No. 61/410312, filed Nov. 4, 2010, the entire disclosures of which are hereby incorporated by reference herein for all purposes.

### BACKGROUND

Traditionally, once a person chose a method of having goods delivered, the goods would be delivered by that method. Unfortunately, if the person decided after the fact that the method was unacceptably slow, or if an opportunity arose for the person to meet the deliverer while en route, the person would nevertheless have to wait for the originally chosen method of delivery to be completed. Further, the options available to the person for communicating with the deliverer were limited. What is needed are systems and methods that provide greater flexibility to a person having goods delivered to change the delivery method once the goods are en route, and in communicating with custodians of the package.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a delivery handoff system for managing the delivery of packages is provided. The system comprises at least one processor and a computer-readable medium having components executable by the at least one processor stored thereon. The components include a package routing engine and a communication engine. The package routing engine is configured to create a package record in a package data store, wherein the package record is associated with a custodian record associated with a current custodian of a package, a custodian record associate with a next custodian of the package, and a custodian record associated with a final custodian of the package. Each custodian record includes an identifier of a handoff mobile device associated with the associated custodian. The package routing engine is further configured to transmit a direction to the handoff mobile device associated with the current custodian to direct the current custodian toward at least the next custodian. The communication engine is configured to establish a communication channel between the handoff mobile device of the final custodian and at least the handoff mobile device of the current custodian.

In some embodiments, a computer-implemented method of managing delivery of a package is provided. A package record is stored in a package data store, wherein the package record is associated with a current custodian of the package and a final custodian of the package. Location information of the final custodian is transmitted to a handoff mobile device associated with the current custodian to guide the current custodian toward the final custodian. A selection of an additional custodian for the package is received. The package record is associated with the additional custodian. Location information of the additional custodian is transmitted to the handoff mobile device associated with the current custodian to guide the current custodian toward the additional custodian instead of the final custodian.

In some embodiments, a computer-readable medium having computer-executable components stored thereon is provided. The computer-executable components, if executed by at least one processor of a computing device, cause the computing device to perform actions for managing delivery of a package. A package record is stored in a package data store, wherein the package record is associated with a current custodian of the package and a final custodian of the package. Location information of the final custodian is transmitted to a handoff mobile device associated with the current custodian to guide the current custodian toward the final custodian. A selection of an additional custodian for the package is received. The package record is associated with the additional custodian. Location information of the additional custodian is transmitted to the handoff mobile device associated with the current custodian to guide the current custodian toward the additional custodian instead of the final custodian.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic drawing that illustrates a problem with traditional delivery methods;

FIGS. 2A and 2B are block diagrams that illustrate embodiments of systems for improving package delivery according to various aspects of the present disclosure;

FIG. 3 is a block diagram that illustrates one embodiment of a delivery handoff system according to various aspects of the present disclosure;

FIG. 4 is a block diagram that illustrates one embodiment of a client computing device according to various aspects of the present disclosure;

FIGS. 5A-5C are a flowchart that illustrates one embodiment of a method of delivering a package via multiple custodians according to various aspects of the present disclosure;

FIG. 6 illustrates one embodiment of a folder interface presented by a client device according to various aspects of the present disclosure;

FIG. 7 illustrates one embodiment of a details interface presented by the client device according to various aspects of the present disclosure;

FIG. 8 illustrates one embodiment of a communications interface presented by the client device according to various aspects of the present disclosure; and

FIG. 9 illustrates aspects of an exemplary computing device appropriate for use with embodiments of the present disclosure.

### DETAILED DESCRIPTION

Throughout this disclosure, package delivery is discussed. In some embodiments, a package may be a box having nonperishable contents, and delivery may be the transportation of a package from a sender to a receiver. In some embodiments, package delivery may include the delivery of food, flowers, documents, and/or any other type of item transported from a sender to a receiver, which may or may not be inside of another container. In some embodiments, the package may be ordered by a receiver from a sender, such as a purchase of goods from an online merchant and/or the like. In some embodiments, the delivery may not be associated with a purchase or order per se, but instead may relate to a package that is to be transferred from a sender to a receiver for other reasons. Though package delivery is discussed below primarily in terms of a package such as a box containing nonperishable contents ordered by a receiver from a sender, this simple example is provided for ease of discussion only and should not be seen as limiting.

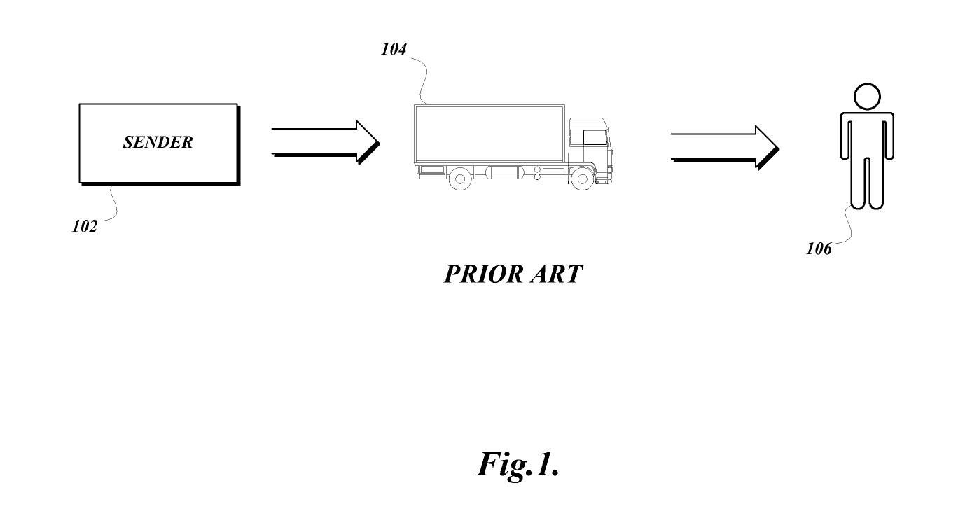

FIG. 1 is a schematic drawing that illustrates a problem with traditional delivery methods. A receiver 106 orders a package from a sender 102, and chooses a traditional delivery method, such as ground transportation by a common carrier 104, as the delivery method. The large arrows in the drawing indicate the custody of the package, which passes from the sender 102 to the common carrier 104, and then from the common carrier 104 to the receiver 106. One problem with this traditional method is that it lacks flexibility. Once custody of the package is transferred from the sender 102 to the common carrier 104, the common carrier 104 is responsible for transporting the package to the receiver 106. The receiver 106 is not provided with any way of communicating with the common carrier 104, nor is the receiver 106 provided with any way of instructing the common carrier 104 to transfer the package to a different delivery method to improve the delivery experience.

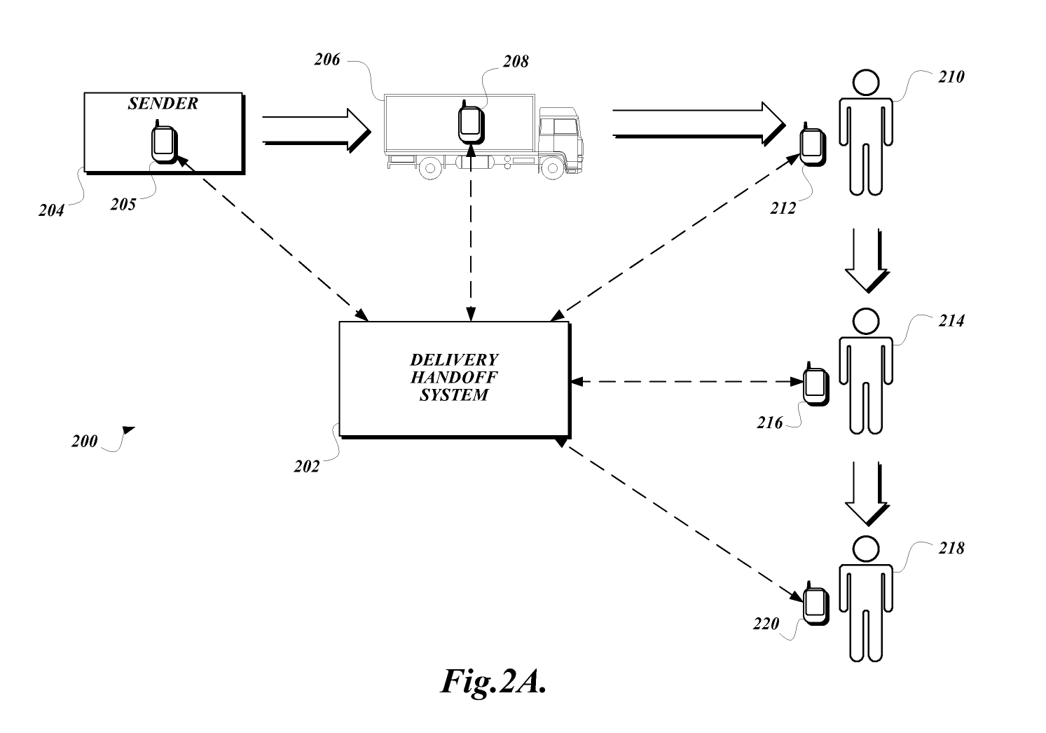

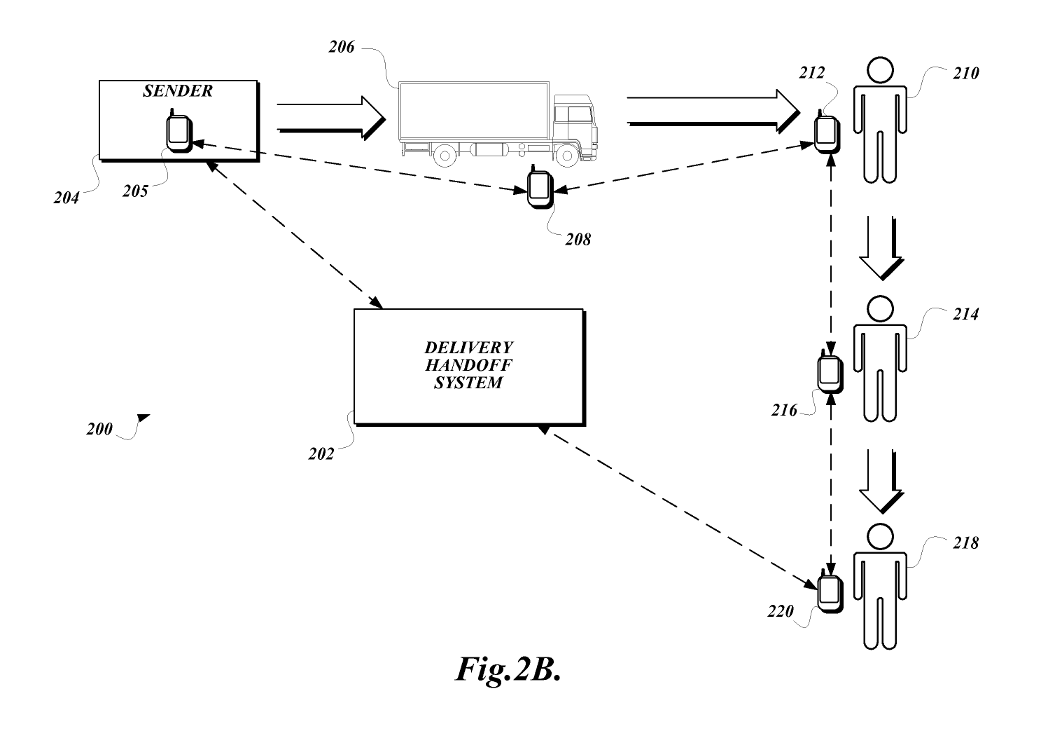

FIG. 2A is a block diagram that illustrates one embodiment of a system 200 for improving package delivery according to various aspects of the present disclosure. As illustrated, various components of the system 200 communicate with a delivery handoff system 202, which facilitates communication between the parties, and which manages handing off packages from one custodian to another. The dashed arrows indicate communication links, while the large arrows indicate the transfer of custody of the package.

A receiver 218 requests a package from a sender 204, and chooses, for example, a common carrier 206 to deliver the package. While the common carrier 206 has custody of the package, the delivery handoff system 202 instructs the common carrier 206 to transfer the package to a first intermediate custodian 210, instead of completing the delivery to the receiver 218. In some embodiments, this instruction may be generated based upon a request by the receiver 218. In some embodiments, the delivery handoff system 202 may automatically detect the opportunity for a handoff that would improve the delivery experience, and may automatically generate the instruction to transfer the package. The first intermediate custodian 210 may then continue transporting the package to the receiver 218, or may be instructed to hand off the package to a second intermediate custodian 214, who will then hand off the package to the receiver 218.

Each of the participants in the delivery of the package is associated with a handoff mobile device 205, 208, 212, 216, 220. As illustrated in FIG. 2A, each handoff mobile device 205, 208, 212, 216, 220 uses a communication channel to the delivery handoff system 202 to interact with the rest of the system 200. As the package is transported from one custodian to another, the package is associated by the delivery handoff system 202 with each handoff mobile device 205, 208, 212, 216, 220 in turn, to indicate within the system 202 the current custodian of the package. For example, when the common carrier 206 arrives at the location of the sender 204 and takes physical possession of the package, the delivery handoff system 202 may verify the proximity of the handoff mobile device 205 associated with the sender 204 and the handoff mobile device 208 of the common carrier 206 to ensure the identity of both parties. The delivery handoff system 202 may then create or update a record indicating that the handoff mobile device 208 is now the custodian of the package, and that the handoff mobile device 205 is no longer responsible for the package. A similar handoff procedure is performed to shift custody of the package from the handoff mobile device 208 of the common carrier 206 to the handoff mobile device 212 of the first intermediate custodian 210, and so on.

In the discussion above, handoff mobile devices were described as being custodians of or having responsibility for delivery of the package. The handoff mobile devices and the parties associated therewith may be discussed herein interchangeably, for ease of discussion. One of ordinary skill in the art will recognize that, if the handoff mobile device 212 is described as the custodian of the package, in reality, the first intermediate custodian 210, who is associated with the handoff mobile device 212, is actually the custodian of the package, and uses the handoff mobile device 212 to interact with the system 202 and so on. Further, one of ordinary skill in the art will recognize that, if the first intermediate custodian 210 is described as communicating with, for example, the receiver 218, in reality the first intermediate custodian 210 may be using the handoff mobile device 212 to communicate to the receiver 218 via the handoff mobile device 2B20.

In some embodiments, the handoff mobile devices may be any suitable computing devices capable of communicating with other components of the system 200. For example, the handoff mobile device 208 associated with the common carrier 206 may be a laptop or other computing device built into the common carrier's vehicle. As another example, the handoff mobile device 212 of the first intermediate custodian 210 may be a smart phone executing a stand-alone application for communicating with the delivery handoff system 202, or connecting to a web application provided by the delivery handoff system 202. As yet another example, the handoff mobile device 220 of the receiver 218 may also be a smart phone, or may be a desktop computer located at the delivery address. This example shows that, in some embodiments, handoff mobile devices may be stationary, as long as the location of the handoff mobile device is known to the delivery handoff system 202.

In some embodiments, the delivery handoff system 202 establishes a secure communication channel between the current custodian of the package and the receiver 218. This allows the receiver 218 to transmit instructions to the current custodian and/or to answer questions the current custodian might have to help make the delivery be completed smoothly. In some embodiments, the secure communication channel follows the custody of the package. In other words, as custody of the package is handed off from the common carrier 206 to the first intermediate custodian 210, the handoff mobile device 208 of the common carrier 208 is removed from the communication channel and the handoff mobile device 212 of the first intermediate custodian 210 is added to the communication channel. In some embodiments, the later custodians are also able to view communications that happened between previous custodians and the receiver 218.

In some embodiments, the delivery handoff system 202 directs each custodian to the next point in the chain of custody. For example, the handoff mobile device 208 and the handoff mobile device 212 may use a suitable locating technology, such as GPS, GSM network locating, dead reckoning, and/or the like, to report their respective positions to the delivery handoff system 202. The delivery handoff system 202 may then direct the handoff mobile device 208 to meet the handoff mobile device 212, such as by providing an address of the handoff mobile device 212, by drawing a route on a map such as is common with GPS navigation systems, by providing a compass pointer indicating the direction of the handoff mobile device 212, by providing a measurement of a range to the handoff mobile device 212, and/or the like. The delivery handoff system 202 may provide a single, stationary location at which the handoff mobile device 212 is located at a given point of time, or may provide updated locations of the handoff mobile device 212 as the first intermediate custodian 210 continues to move. The delivery handoff system 202 may provide directions to both the handoff mobile device 208 and the handoff mobile device 212 to more quickly facilitate the meeting and handoff of the package.

In the embodiment illustrated in FIG. 2A, the handoffs and communications are facilitated by the delivery handoff system 202. Each of the handoff mobile devices communicates with the delivery handoff system 202 via a suitable network, such as over the Internet, via WiFi, WiMAX, 3G, 4G, LTE, and/or the like. In other embodiments, the handoff mobile devices may communicate directly with each other for some purposes. For example, in FIG. 2B, peer-to-peer communication channels are also established directly between the handoff mobile devices. This communication may be over a mobile ad hoc network, a Bluetooth connection, an infrared connection, and/or the like. This peer-to-peer communication channel may be used to securely pass a “bread crumb” or other token indicating custody of the package from one handoff mobile device to another without the intervention or validation of the delivery handoff system 202. In some embodiments, the delivery handoff system 202 may simply communicate with the sender 204 and the receiver 218, and the bread crumb may be used to forward the package from one custodian to another. In such an embodiment, the bread crumb may contain sufficient information for each custodian to find either the next custodian or the receiver, and may contain contact information that allows each custodian in turn to proactively open a communication channel directly with the receiver 218.

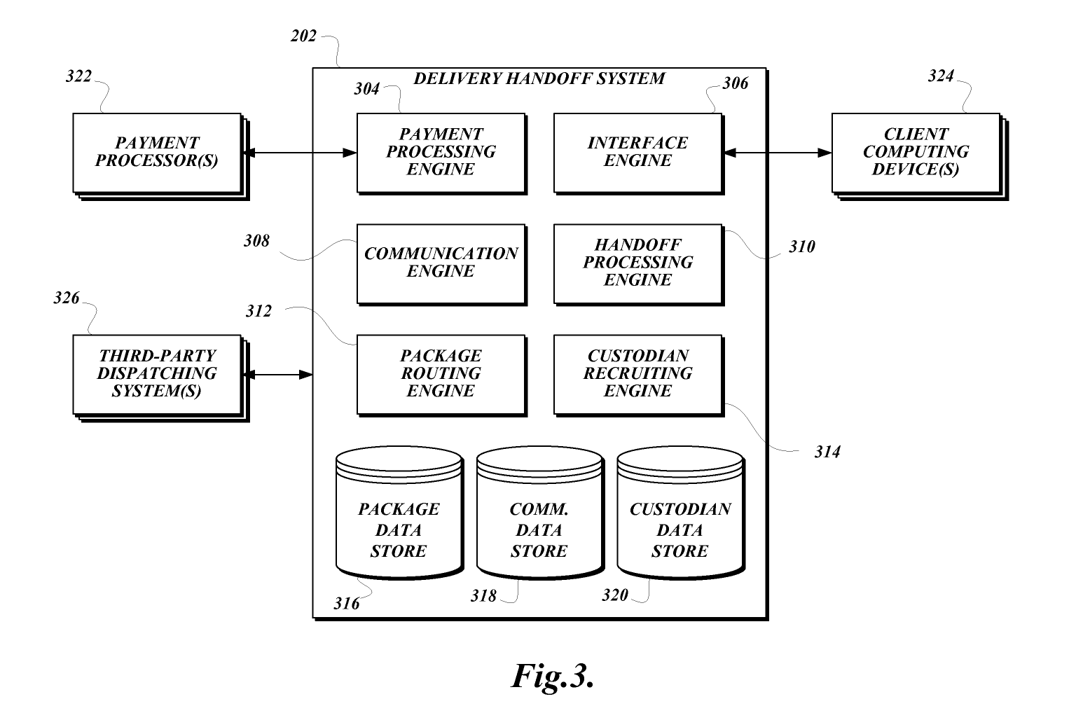

FIG. 3 is a block diagram that illustrates one embodiment of a delivery handoff system 202 according to various aspects of the present disclosure. As illustrated, the delivery handoff system 202 includes a payment processing engine 304, an interface engine 306, a communication engine 308, a handoff processing engine 310, a package routing engine 312, and a custodian recruiting engine 314. The illustrated embodiment also includes a package data store 316, a communications data store 318 (abbreviated “comm. data store”), and a custodian data store 320.

In some embodiments, the interface engine 306 communicates with one or more client computing devices 324, such as the previously described handoff mobile devices, to provide access to the engines and data stores of the delivery handoff system 202. In some embodiments, the interface engine 306 may provide a graphical web page interface giving access to functionality of the other engines or data stores of the delivery handoff system 202 via a standard web browser executing on the client computing device 324. In some embodiments, the interface engine 306 may provide one or more web services or other application programming interfaces by which a custom application executing on one or more client devices 324 may interact with the functionality provided by the delivery handoff system 202. For ease of discussion, some of the other engines of the delivery handoff system 202 may be described herein as communicating directly with client computing devices 324, payment processors 322, or third-party dispatching systems 326, but in some embodiments, all communication between the delivery handoff system 202 and external devices may pass through the interface engine 306.

In some embodiments, the custodian data store 320 stores information about users of the delivery handoff system 202, including senders, receivers, and various other intermediate custodians who transport packages from senders to receivers. Particular information about custodians stored in the custodian data store 320 is described further below, but includes at least information identifying the custodian and information usable to determine a current location of the custodian. Representing senders, receivers, and intermediate custodians in similar ways within the delivery handoff system 202 provides a great deal of flexibility. Rerouting a package from one custodian to another on its way to the receiver may allow reuse of similar functionality no matter at what point in the chain of custody the package is currently found. For example, a receiver may request that the package be handed off to a different custodian while the package is still in custody of the receiver 218, or while the package is in the custody of any of several intermediate custodians, all using the same interface and same steps, since each is represented as a custodian. As another example, routing custodians together may use the same or similar functionality whether routing an intermediate custodian to a sender 204, routing an intermediate custodian to the receiver 218, or routing intermediate custodians to each other, since all of the parties are represented similarly within the system. Accordingly, the receiver 218 may alternatively be referred to herein as a final custodian.

In some embodiments, the package data store 316 stores information about packages being tracked by the delivery handoff system 202. The package data store 316 may store information relevant to the delivery of each package, such as a package identifier, an identifier of a sender, an identifier of a receiver, an identifier of a current custodian, and an identifier of one or more future custodians. The identifiers of each of these entities may link to records within the custodian data store 320 that have further information concerning each entity relevant to the delivery, such as a current location, an expected future location, and/or the like.

In some embodiments, the communication engine 308 is configured to establish a communication channel between at least a current custodian and the receiver 218 and forwards messages between the two parties. The communication engine 308 may also be configured to store a copy of the messages in a communications data store 318 for later reference. In some embodiments, the package routing engine 312 and the custodian recruiting engine 314 are configured to determine one or more custodians for the package and to direct the custodians to the package, to the receiver, and/or to other custodians for package handoffs.

In some embodiments, the handoff processing engine 310 is configured to verify that a handoff of a package from a current custodian to a subsequent custodian has taken place correctly, and to update records within the delivery handoff system 202 accordingly. Verification of a handoff by the handoff processing engine 310 may include one of a number of techniques to verify an identity of an individual claiming to be the subsequent custodian assigned by the delivery handoff system 202.

As one example, in some embodiments, the handoff processing engine 310 may obtain an identifier of a handoff mobile device 220 used by the purported subsequent custodian, and may compare the identifier to an identifier associated with the appropriate custodian record indicated in the package record stored in the package data store 316. If the identifier does not match the identifier of the expected subsequent custodian, the handoff may not be verified. If the handoff is not verified, the handoff processing engine 310 may transmit a notification to the current custodian indicating that the package should not be given to the purported subsequent custodian.

As another example, in some embodiments, proximity of the handoff mobile devices may be used to verify the handoff of a package. In such an embodiment, the handoff processing engine 310 may detect a location of the current custodian and a location of the subsequent custodian. Once the current custodian and the subsequent custodian are detected within a predetermined radius of each other, the handoff processing engine 310 may send a notification to both custodians to enable a signoff interface element on the respective handoff mobile devices. Once both custodians have actuated the signoff interface element, the handoff processing engine 310 will consider the handoff verified.

As yet another example, in some embodiments, information is provided by the subsequent custodian to verify its identity. For example, the subsequent custodian may be given a passcode or passphrase, and this passcode or passphrase is given by the subsequent custodian to the current custodian to verify its identity. As another example, the current custodian may be given identifying information of the subsequent custodian, such as a name, picture, identifier, and/or the like, which the current custodian may verify once the subsequent custodian arrives. In either example, the current custodian may either submit the information to the handoff processing engine 310 for verification, or may self-verify the information (comparing the subsequent custodian to a picture of the subsequent custodian, comparing a passphrase provided by the subsequent custodian to a passphrase previously provided by the handoff processing engine 310, and/or the like) and report the verification back to the handoff processing engine 310.

In some embodiments, evidence of the physical transfer of the package from the current custodian to the subsequent custodian may be used by the handoff processing engine 310 to verify the handoff. For example, the subsequent custodian may obtain the package, and then scan or otherwise enter an identifier on the package into its handoff mobile device. The handoff mobile device may then transmit the package identifier to the handoff processing engine 310 for verifying and processing the handoff.

In addition to the functionality described below that may take place during a delivery, in some embodiments, the custodian recruiting engine 314 is also configured to provide functionality related to adding potential custodians to the system. In some embodiments, the custodian recruiting engine 314 may use the interface engine 306 to generate one or more web page interfaces by which individuals or dispatching entities may sign up to be considered as potential custodians. When signing up, new custodians may specify information describing the service offered by the new custodian, such as a type of transportation available (car, delivery truck, bicycle, foot, and/or the like), a desired service area, a minimum and/or maximum trip length, a flat or per-distance service charge, an identifier of a client device associated with the new custodian to be used as a handoff mobile device, and/or the like. This custodian recruiting functionality may also be used to activate a future sender 204 and/or receiver 218 to use the delivery handoff system 202 to manage deliveries. In some embodiments, new custodians may specify other custodians that they are willing to use as custodians for their own deliveries, or that they are willing to act as custodians for. This friend-linking functionality may integrate with a third-party social networking service, such as Google Plus, Facebook, Twitter, and/or the like, to specify groups of users.

Further descriptions of the configuration of the communication engine 308, the package routing engine 312, the custodian recruiting engine 314, and the handoff processing engine 310 are provided below.

In some embodiments, the payment processing engine 304 communicates with one or more payment processors 322 operated by third parties, such as banks, credit card companies, online payment providers, and/or the like. As will be described in further detail below, a receiver 218 may submit an instruction to have an en-route delivery transferred to a new custodian, which may be referred to as a “boost” because the delivery time may be reduced by doing so. The new custodian and/or the delivery handoff system 202 itself may charge a fee for altering the delivery or for using a more expensive delivery mechanism than the originally chosen mechanism. The payment processing engine 304 allows the delivery handoff system 202 to process such charges.

In general, the word “engine” (used interchangeably with the word “application”), as used herein, refers to logic embodied in hardware or software instructions, which can be written in a programming language, such as C, C++, COBOL, JAVA™, PHP, Per1, HTML, CSS, JavaScript, VBScript, ASPX, Microsoft .NET™πlanguages such as C#, and/or the like. An engine may be compiled into executable programs or written in interpreted programming languages. Software engines or applications may be callable from other engines or from themselves. Generally, the engines or applications described herein refer to logical modules that can be merged with other engines or applications, or can be divided into sub-engines. The engines or applications can be stored in any type of computer-readable medium or computer storage device and be stored on and executed by one or more general purpose computers, thus creating a special purpose computer configured to provide the engine or application.

As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed packet switched network. However, any other suitable storage technique and/or device capable of quickly and reliably providing the stored data in response to queries may be used, and the computing device may be accessible locally instead of over a network, or may be accessible over some other type of suitable network or provided as a cloud-based service. A data store may also include data stored in an organized manner on a storage medium 908, as described further below. One of ordinary skill in the art will recognize that separate data stores described herein may be combined into a single data store, and/or a single data store described herein may be separated into multiple data stores, without departing from the scope of the present disclosure.

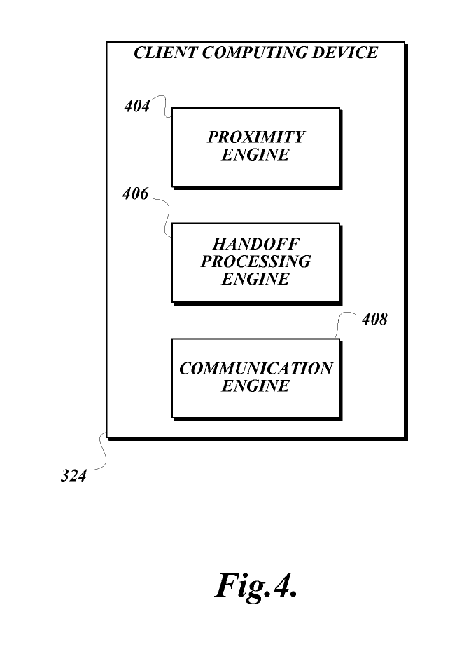

FIG. 4 is a block diagram that illustrates one embodiment of a client computing device 324 according to various aspects of the present disclosure. In some embodiments, the client computing device 324 may be a smart phone, but any other suitable computing device may be used without departing from the scope of the present disclosure. The client computing device 324 includes a proximity engine 404, a handoff processing engine 406, and a communication engine 408. In some embodiments, the logic of these engines is provided by the corresponding engines of the delivery handoff system 202, and the engines on the client computing device 324 act as local interfaces to the remote engine services. In some embodiments, these engines may operate in an offline mode, in which they are configured to process handoff-related actions without the participation of the delivery handoff system 202.

The proximity engine 404 is configured to provide location-related functionality for the client computing device 324. For example, after being provided with the location of a subsequent custodian, a previous custodian, or the receiver 218, the proximity engine 404 may be configured to obtain a current location of the client computing device 324 by querying a location service of the client computing device 324 to obtain location information, and to then generate an indication for presentation to the user of a direction of travel to meet the next party. The indication may be in any suitable format, such as a graphical depiction of a route on a map, a set of driving directions, a directional pointer, and/or the like.

The handoff processing engine 406 is configured to provide handoff-related functionality for the client computing device 324. This functionality may include, but is not limited to, verifying that the user of the client computing device 324 has met the previous or next custodian in the chain of custody, sending or receiving a bread crumb data object to the next or previous custodian, and/or the like. In some embodiments, the handoff processing engine 406 may autonomously verify the identity of the next custodian or the previous custodian based on information securely stored in the bread crumb data object and accessible only to the handoff processing engine 406 using standard data encryption and protection techniques. In some embodiments, the handoff processing engine 406 may perform some autonomous verification, but may connect to the delivery handoff system 202 for final verification and to inform the delivery handoff system 202 that the handoff has taken place. Further description of handoff-related verification is provided below.

The communication engine 408 is configured to allow the user of the client computing device 324 to communicate with other parties in the chain of custody of the package. In some embodiments, when operated by the receiver 218, the communication engine 408 is configured to display the history of communication between the receiver 218 and each of the custodians who were at some point involved in the delivery of the package. In some embodiments, when operated by another custodian, the communication engine 408 may be configured to display communication between the custodian and the receiver 218 only, or may be configured to display communication between the custodian and the receiver 218 as well as communication between the receiver 218 and previous custodians but not future custodians. In some embodiments, the communication engine 408 is configured to relay communications through the delivery handoff system 202. In some embodiments, the communication engine 408 may be configured to relay communications through a third-party communication system. In some embodiments, the communication engine 408 may be configured to connect directly to subsequent or previous custodians in the chain of custody to transfer communications. Further description of communication-related functionality is provided below.

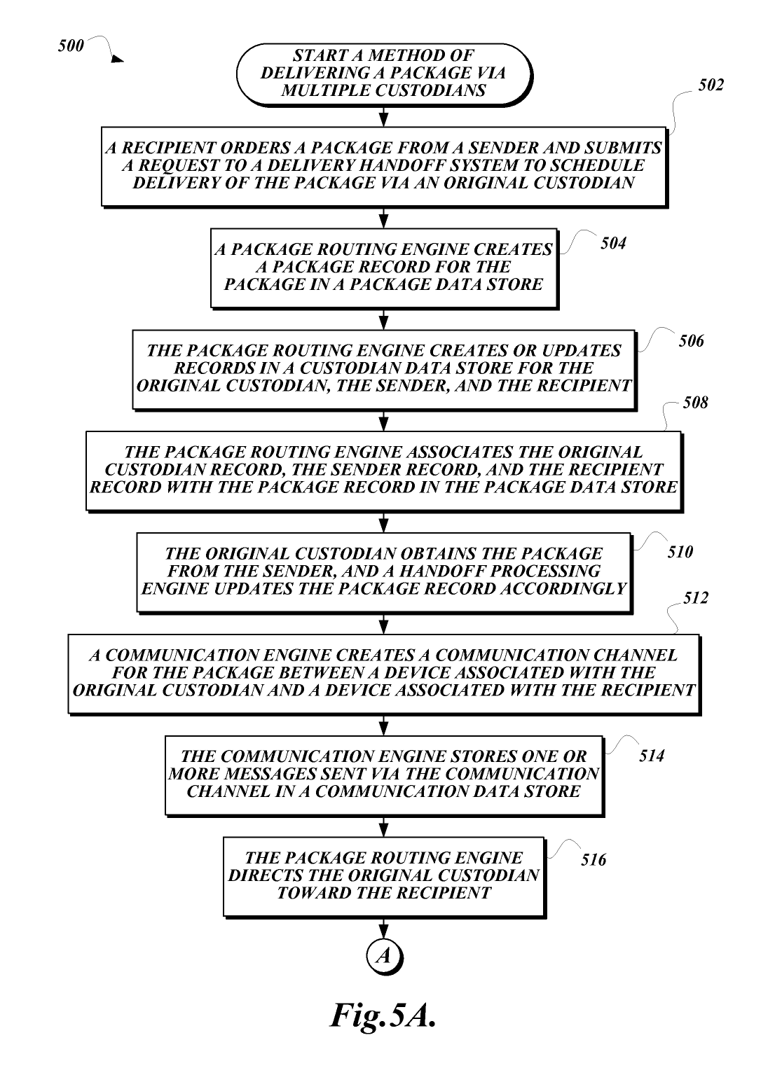

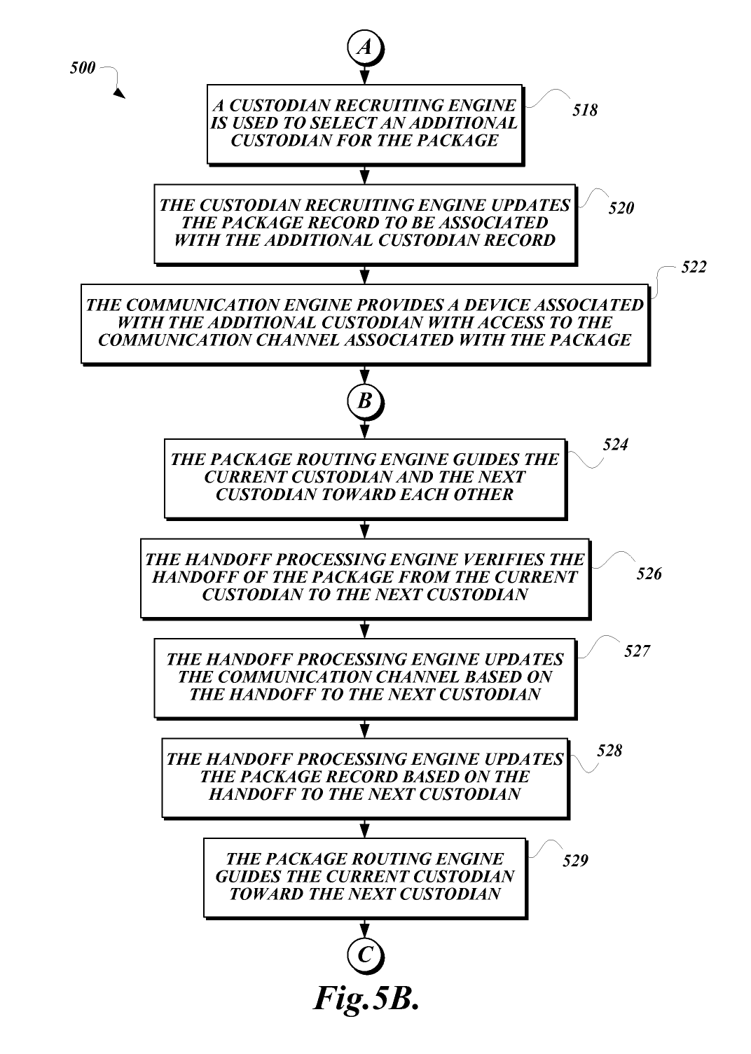

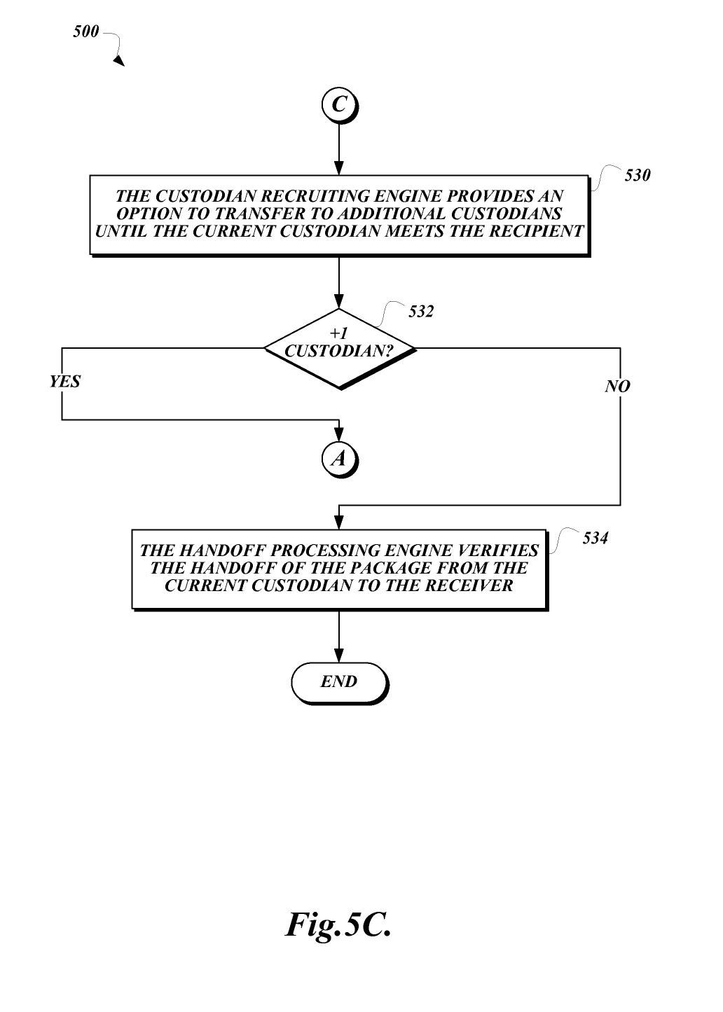

FIGS. 5A-5C are a flowchart that illustrates one embodiment of a method 500 of delivering a package via multiple custodians, according to various aspects of the present disclosure. From a start block, the method 500 proceeds to block 502, where a receiver 218 orders a package from a sender 204 and submits a request to a delivery handoff system 202 to schedule delivery of the package via an original custodian. The original custodian may be a traditional form of delivery, such as a ground-based courier using delivery trucks, a customer pick-up, a specialized courier delivery, and/or the like. In some embodiments, the delivery may be scheduled by the sender 204, as opposed to the receiver 218, such as for a regularly scheduled delivery, a promotional delivery, or any other type of sender-initiated delivery. In some embodiments, the delivery may be scheduled by a third party. For example, a third party may order a gift from the sender 204 to be delivered to the receiver 218.

At block 504, a package routing engine 312 creates a package record for the package in a package data store 316. The package record may include a unique package identifier generated by the package routing engine 312 or the package data store 316, a name of the delivery assigned by the sender 204 or the receiver 218, an invoice number generated by the sender 204, and/or the like. Next, at block 506, the package routing engine 312 creates or updates records in a custodian data store 320 for the original custodian, the sender 204, and the receiver 218. Each custodian record may include a unique custodian identifier; a name of the custodian; a passcode for validating access by the custodian, a human-readable identifier of the custodian (such as a truck number, license plate number, and/or the like); contact information for the custodian such as a phone number, email address, and/or the like; payment account information for the custodian at a payment processor 322; and an identifier of a handoff mobile device associated with the custodian. Each custodian record may also include a location of the custodian, which may be obtained from the locating functionality of the handoff mobile device upon its connection to the delivery handoff system 202, or may be entered as part of the ordering process (such as a stationary delivery address).

In some embodiments, the package routing engine 312 may only create or update records in the custodian data store 320 for the sender 204 and the receiver 218 at this point, and may associate the delivery with a generic custodian. For example, if a courier service with centralized dispatching is specified as the original custodian, the particular handoff mobile device associated with the individual custodian dispatched to pick up the package may not be known until the actual time of pickup. Accordingly, the package routing engine 312 may create a generic custodian record in the custodian data store 320 for the dispatching service, and may create the original custodian record once the individual custodian is known. In some embodiments, the package routing engine 312 may communicate with a third-party dispatching system 326 to obtain the identity information associated with the individual custodian dispatched as the original custodian. In some embodiments, the package routing engine 312 may not create an individual custodian record, but may instead use the generic custodian record for the dispatching service, and rely on information provided by the dispatching service regarding the identity or location of dispatched custodians.

At block 508, the package routing engine 312 associates the original custodian record (if available), the sender record, and the receiver record with the package record in the package data store 316. In some embodiments, the package record may be associated with a current custodian identifier, a final custodian identifier, and a set of intermediate custodian identifiers. The delivery handoff system B02 would then guide the custodians to transfer the package from the custodian associated with the current custodian identifier, through the custodians associated with the set of intermediate custodian identifiers, to the custodian associated with the final custodian identifier. In the example above, at block 508 the custodian identifier of the sender 204 would be assigned as the current custodian identifier, the custodian identifier of the receiver 218 would be assigned as the final custodian identifier, and the custodian identifier of the original custodian (or the generic custodian) would be added to the set of intermediate custodian identifiers.

The method 500 then proceeds to block 510, where the original custodian obtains the package from the sender 204, and a handoff processing engine 310 updates the package record accordingly. For example, the handoff processing engine 310 may remove the custodian identifier of the sender 204 as the current custodian identifier, add the custodian identifier for the original custodian as the current custodian identifier, and remove the custodian identifier for the original custodian from the set of intermediate custodian identifiers. In some embodiments, the handoff processing engine 310 may also verify the handoff to the original custodian, as described above.

At block 512, a communication engine 308 creates a communication channel for the package between a device (such as a handoff mobile device) associated with the original custodian and a device (such as a handoff mobile device) associated with the receiver. In some embodiments, creating the communication channel may include opening a network connection to the device associated with the original custodian and a network connection to the device associated with the receiver, and forwarding received communication from one to the other. In some embodiments, creating the communication channel may include creating a communication channel record within a communication data store 318. The communication channel record may associate a network address (such as an IP address, a phone number, and/or the like) of the device associated with the original custodian and a network address of the device associated with the receiver with the package identifier. Messages received by either device may include the package identifier, and the communication engine 308 would use the package identifier to find the appropriate record for routing the message. In some embodiments, the communication channel record may contain the package identifier, the custodian identifier of the original custodian, and the custodian identifier of the receiver, and the network address information may be stored in the custodian records in the custodian data store 320.

As the communication engine 308 may be used to route communications between the custodian and the receiver 218, the actual contact information for both parties may be kept confidential. This may encourage both the custodian and the receiver 218 to communicate via the communication channel, because the likelihood of unwanted future communication outside of the communication channel is kept to a minimum. Further, as the communication engine 308 may control which devices will be usable to contact the receiver 218 via the communication channel, security may be maintained.

Once the communication channel is established, the original custodian and the receiver may exchange messages. At block 514, the communication engine stores one or more messages sent via the communication channel in the communication data store 318. The saved messages may be displayed to future custodians, as will be discussed further below. The actions in block 514 are optional, in that in some embodiments, the receiver 218 and the original custodian may choose not to exchange any messages.

At block 516, the package routing engine 312 directs the original custodian toward the receiver 218 by providing a map, a route, an address, a directional arrow, and/or the like, as discussed above. The method 500 then proceeds to a continuation terminal (“terminal A”). From terminal A (FIG. 5B), the method 500 proceeds to block 518, where a custodian recruiting engine 314 is used to select an additional custodian for the package. In some embodiments, the custodian recruiting engine 314 may be invoked by an instruction submitted by the receiver 218 to increase the speed of the delivery or to change the custodian for other reasons. In some embodiments, the delivery handoff system 202 may automatically choose to recruit an additional custodian upon determining that the existing custodians will not be able to deliver the package as arranged. In some embodiments, the process of selecting an additional custodian may be initiated by an existing custodian in the chain of custody.

The custodian recruiting engine 314 may query the custodian data store 320 to determine other potential custodians for the package. In some embodiments, the custodian recruiting engine 314 may determine a current location of the current custodian, either by retrieving the current location from the custodian record in the custodian data store 320, or by transmitting a query directly to the handoff mobile device associated with the current custodian. The custodian recruiting engine 314 may then query the custodian data store 320 for other custodians within a predetermined radius of the current custodian, or from a predicted future location of the current custodian. The predetermined radius may be different for different types of custodians. For example, if a custodian record indicates that the potential additional custodian would travel in a car, then the predetermined radius may be larger than if the custodian record indicated that the potential additional custodian would travel by bicycle or on foot. In some embodiments, the custodian recruiting engine 314 may calculate routes for a set of potential additional custodians from the current location of the potential additional custodian, to the current location of the current custodian, and to the location of the receiver 218, and may choose potential additional custodians based on the length, time, or cost involved with the calculated route. In some embodiments, the receiver 218 may have previously stored an indication of acceptable custodians, such as filtering by type of custodians (including or excluding common carriers, bicycle messengers, taxis, and/or the like) or by specifying a list of acceptable custodians, and the custodian recruiting engine 314 may determine if any of the limited list or otherwise acceptable custodians would be appropriate as an additional custodian.

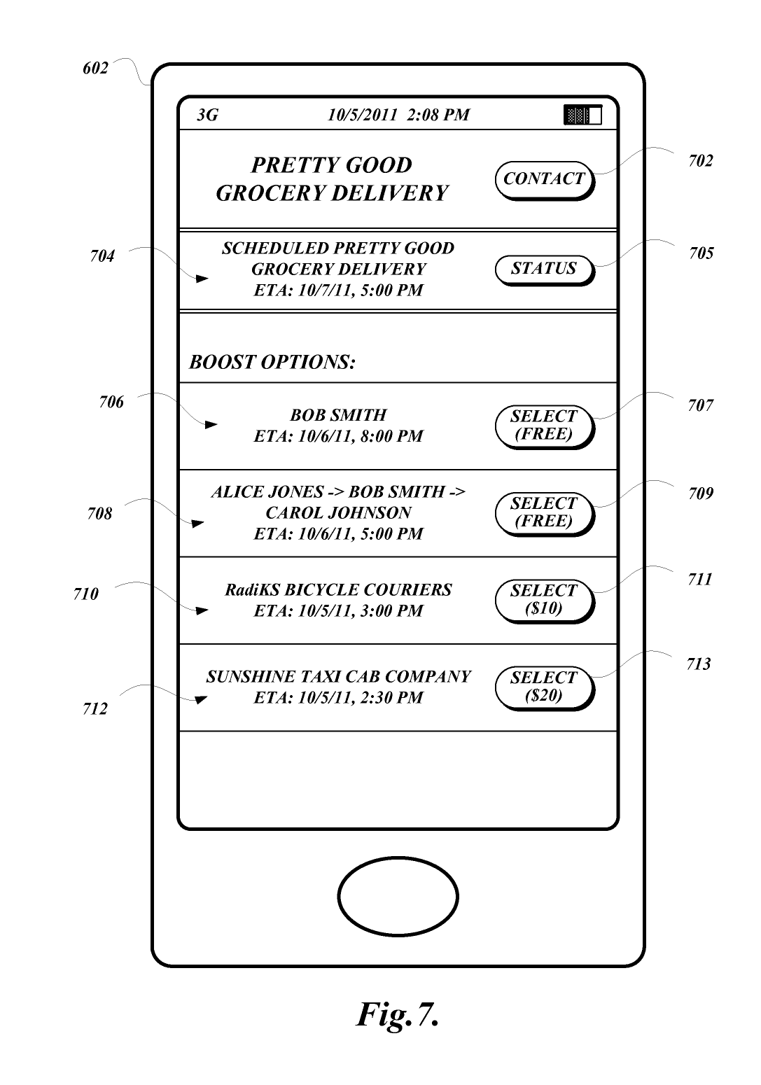

In some embodiments, a set of potential custodians is presented to the receiver 218, and the receiver 218 may pick one of the potential custodians to be an additional custodian. Further description of such an embodiment is provided below with respect to FIG. 7. In some embodiments, the identified custodian may be sent a notification that they have been selected, and may be given the option to accept or deny the offer to act as a custodian for the package.

Once the additional custodian has been identified, the method 500 proceeds to block 520, where the custodian recruiting engine 314 updates the package record in the package data store 316 to be associated with the additional custodian record. In some embodiments, the custodian identifier of the additional custodian may be added to the set of intermediate custodian identifiers associated with the package record. At block 522, the communication engine provides a device (such as a handoff mobile device) associated with the additional custodian with access to the communication channel associated with the package. In some embodiments, providing access to the device may include opening a network connection to the device, and forwarding received communication from any of the three devices to all three connected devices. In some embodiments, providing access may include adding a network address or the custodian identifier of the device associated with the additional custodian to a communication channel record, and routing messages from any of the three devices associated with the communication channel record to all three devices. In some embodiments, providing access may include querying the communications data store 318 for previous stored communications between the receiver 218 and the previous custodians, and transmitting the previous stored communications to the device of the additional custodian for display. Similar to the discussion above with respect to the communication channel between the current custodian and the receiver 218, the communication engine 308 may store communications transmitted between the current custodian, the additional custodian, and the receiver 218 in the communication data store 318. In some embodiments, access to the communication channel may not be provided to the additional custodian until the package has been handed off to the additional custodian.

The method 500 then proceeds to a continuation terminal (“terminal B”). The method 500 may perform the steps between terminal A and terminal B for adding additional custodians to the chain of custody more than once while a current custodian has custody of the package.

From terminal B, the method 500 proceeds to block 524, where the package routing engine 312 guides the current custodian and the next custodian toward each other. The next custodian may be chosen by the package routing engine 312 from the set of intermediate custodian identifiers, either in order or by determining an optimal next custodian from the set. In some embodiments, the next custodian may change if an additional custodian is added to the set of intermediate custodian identifiers while the current custodian is en route, and the destination of the current custodian would be updated accordingly. In some embodiments, the package routing engine 312 may instruct the current custodian to stop and wait for the next custodian, and may guide the next custodian to the location of the current custodian via one or more of the techniques discussed above. In some embodiments, the package routing engine 312 may guide the current custodian to the location of the next custodian via one or more of the techniques discussed above. In some embodiments, the package routing engine 312 may determine an optimal meeting point for the current custodian and the next custodian, and may guide both parties to the meeting point to reduce an amount of time either party has to wait, to reduce an amount of distance traveled, and/or the like.

Once the current custodian and the next custodian are in the same location, the method 500 proceeds to block 526, where the handoff processing engine 310 verifies the handoff of the package from the current custodian to the next custodian. In some embodiments, the procedure used to verify the handoff is similar to the one discussed above with respect to the handoff between the original custodian and the sender 204.

Once the handoff has been verified, the method 500 proceeds to block 527, where the handoff processing engine 310 updates the communication channel based on the handoff to the next custodian. In embodiments wherein creating the communication channel includes opening network connections to the devices, the network connection to the device associated with the current custodian is closed. In embodiments wherein creating the communication channel includes creating a communication channel record, the custodian identifier of the current custodian is removed from the communication channel record. At block 528, the handoff processing engine 310 updates the package record based on the handoff to the next custodian. In some embodiments, the handoff processing engine 310 removes the custodian identifier of the current custodian from the package record, removes the custodian identifier of the next custodian from the set of intermediate custodian identifiers, and adds the custodian identifier of the next custodian as the current custodian identifier. In some embodiments, the removed custodian identifiers may be stored in a log along with a record of the handoff.

Once the handoff is completed, the method 500 proceeds to block 529. From block 529 onward, the “next custodian” is known as the “current custodian,” because the handoff has been completed. At block 529, the package routing engine 312 guides the current custodian (formerly named the “next custodian”) toward the next custodian. In some embodiments, there may be more than one intermediate custodian specified in the set of intermediate custodian identifiers. In such an embodiment, the set of intermediate custodian identifiers may be in a specified order, or the package routing engine 312 may dynamically choose an order for the intermediate custodians based on the locations of the custodians and/or other conditions. In such an embodiment, the package routing engine 312 may instead guide the current custodian toward an intermediate custodian instead of directly toward the receiver. If there are no further intermediate custodians, the next custodian may be the receiver, and the current custodian would be guided accordingly. The method 500 then proceeds to a continuation terminal (“terminal C”). From terminal C (FIG. 5C), the method 500 proceeds to block 530, where the custodian recruiting engine 314 provides an option to transfer to additional custodians until the current custodian meets the receiver 218. Once the current custodian passes a certain point, such as a predetermined time threshold before an expected arrival or departure time, a predetermined distance threshold, and/or the like, the current custodian may be considered to have arrived at the receiver 218. Until that arrival occurs, the receiver 218 may submit an instruction to the delivery handoff system 202 indicating that additional custodians are desired. At decision block 532, a test is performed to determine whether additional custodians are desired and if the current custodian has not yet arrived at the receiver 218. If the answer to the test in decision block 532 is YES, indicating that at least one additional custodian is desired and that the current custodian has not yet arrived at the receiver 218, the method 500 proceeds to a continuation terminal (“terminal A”), and from there returns to terminal A of FIG. 5B to add the additional custodian or custodians.

If the answer to the test in decision block 532 is NO, indicating that no additional custodians are desired, the method 500 proceeds to block 534 once the current custodian arrives at the receiver 218. At block 534, the handoff processing engine 310 verifies the handoff of the package from the current custodian to the receiver 218 via a procedure similar to the handoff verification procedures described above. The method 500 then proceeds to an end block and terminates.

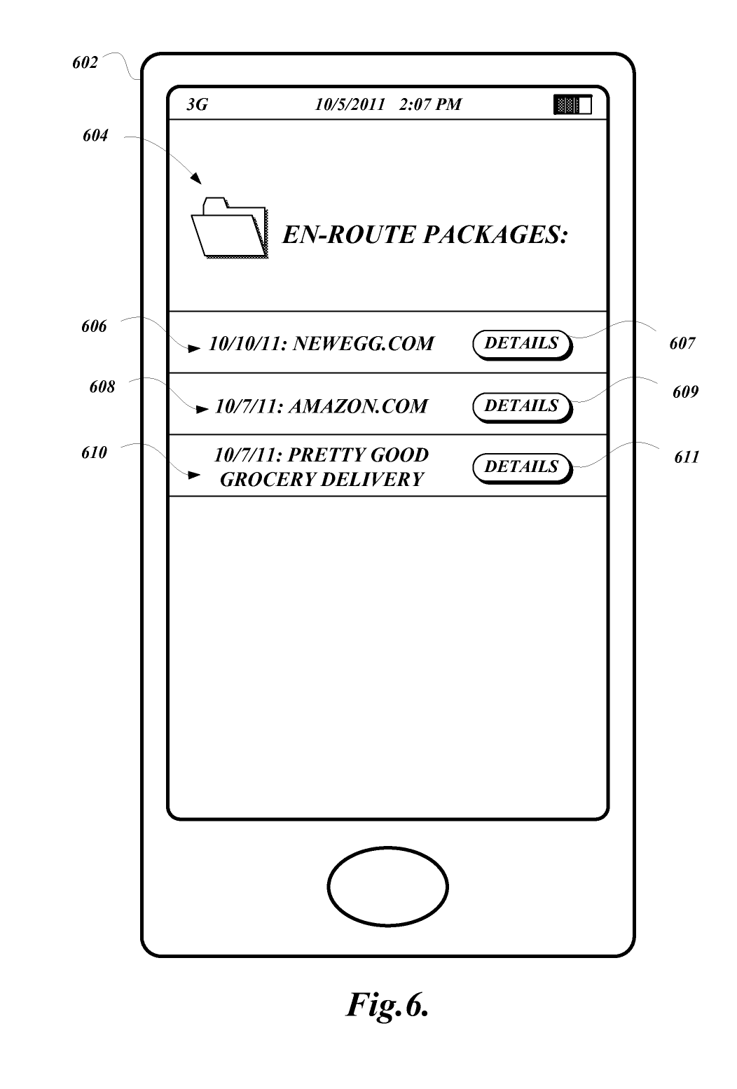

FIG. 6 illustrates one embodiment of a folder interface presented by a client device 602, such as handoff mobile device 220 associated with a receiver 218, according to various aspects of the present disclosure. In some embodiments, the folder interface may be presented after tapping, clicking, or otherwise selecting a folder from a standard folder list, wherein the selected folder includes references to packages en route to the receiver 218. As illustrated, the package folder 604 is shown at the top of the display. The folder interface includes a listing for a first package 606, a second package 608, and a third package 610. Each listing includes a date the package is currently expected to be delivered and a name of the delivery for ease of identification. The name of the delivery may be the name of the sender 204, a name created by the receiver 218 when ordering the package, or any other suitable name. Each listing also includes a details interface button 607, 609, 611 that, if actuated, provides further details and functionality related to the selected package as described further below.

In some embodiments, the client device 602 queries the delivery handoff system 202 to retrieve the list of packages by supplying an identifier associated with the receiver 218, the client device 602, and/or the like. In some embodiments, the client device 602 may store locally a list of package identifiers, and may query the delivery handoff system 202 for each individual package identifier. As described above with respect to the interface engine 306, the interface (as well as the further interfaces to be described below) may be generated by the interface engine 306 and transmitted to the client device 602 for display, may be generated by the client device 602 after retrieving data to be displayed from an application programming interface provided by the interface engine 306, and/or the like.

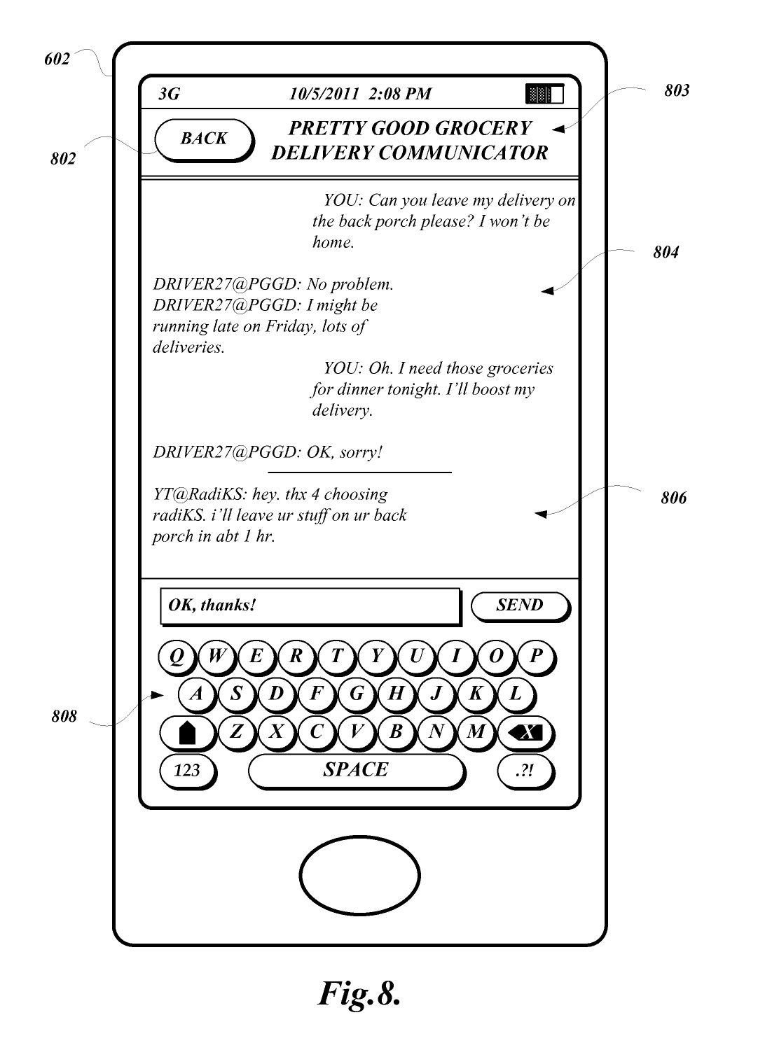

FIG. 7 illustrates one embodiment of a details interface presented by the client device 602, according to various aspects of the present disclosure. As illustrated, the details interface shows an example of details that may be displayed after selecting the details interface button 611 illustrated in FIG. 6. In a top portion of the interface, the name of the delivery is displayed, along with an estimated time of arrival based on the status of the current custodian (and future scheduled custodians, if any). A contact interface button 702 and a status interface button 705 are also presented. Actuating the status interface button 705 may cause further details related to the current schedule to be presented, such as a current location of the package and/or custodian, any subsequently scheduled delivery actions such as handoffs to other custodians, and/or the like. The details may be presented as text in a chart, as graphical indicators on a map, and/or in any other suitable format. Actuating the contact interface button 702 may cause an interface similar to the interface illustrated in FIG. 8 and described below to be presented.

The details interface may also provide one or more options for instructing the delivery handoff system 202 to arrange handing off of the delivery to one or more additional custodians. In some embodiments, the one or more options may be determined by the custodian recruiting engine 314 and transmitted to the client device 602 for selection. Each option includes a description of the option and an interface button for selecting the option. Several exemplary types of custodians are illustrated, but should not be seen as limiting, as other types of custodians may be used instead of or in addition to these examples.

A first boost option description 706 illustrates a custodian that is an individual. In the illustrated example, the individual's name is “Bob Smith,” and the delivery handoff system 202 determined that Bob Smith would be able to obtain the package from the Pretty Good Grocery Delivery custodian and deliver it to the receiver 218 at about 8:00 PM on Oct. 6, 2011, which would be sooner than the previously scheduled delivery that is estimated to arrive at 5:00 PM on Oct. 7, 2011. Bob Smith may be a friend of the receiver 218 who has signed up with the delivery handoff system 202 as a potential custodian for the receiver's packages. For example, Bob Smith may be a neighbor of the receiver 218, or a friend of the receiver who drives past the receiver's house on the way home from work. In the illustrated example, Bob Smith may have indicated to the delivery handoff system 202 (or the delivery handoff system 202 may have automatically determined based on Bob Smith's information) that he could obtain the package and deliver it to the receiver 218 by the specified time.

The illustrated option also includes a first boost selection interface button 707. Actuating the first boost selection interface button 707 would instruct the delivery handoff system 202 to add Bob Smith as an intermediate custodian in the package record. As illustrated, the first boost selection interface button 707 also shows a cost of selecting the first boost option. For the first boost selection, there would be no cost, which may be because Bob Smith is a friend of the receiver 218 and has therefore offered to act as a custodian to help out the receiver 218 without charging a fee.

A second boost option description 708 illustrates using multiple custodians in a single selection. In the illustrated example, the delivery handoff system 202 has determined that, if the system were to be used to hand off the package from the Pretty Good Grocery Delivery custodian to Alice Jones, who would hand the package off to Bob Smith, who would hand the package off to Carol Johnson for delivery to the receiver 218, the package would be delivered at about 5:00 PM on Oct. 6, 2011. The custodian recruiting engine 314 may make this determination based on the location of each of the potential custodians, the schedule of each of the potential custodians, and/or the like. For example, the custodian recruiting engine 314 may be aware that Bob Smith's schedule on Oct. 6, 2011, would allow him to hand the package off from Alice to Carol in the middle of the day, even though the first boost option showed that Bob would not be able to deliver the package until 8:00 PM if he were doing so himself. A second boost selection interface button 709 indicates that, for the second boost selection, a fee of $2 would be assessed by the payment processing engine 304. This fee may be for any purpose, such as to compensate one or more of the custodians, to compensate the operator of the delivery handoff system 202 for the more complicated routing involved, and/or the like.

A third boost option description 710 illustrates the use of a bicycle courier as a potential custodian. In some embodiments, the bicycle courier may be tracked as an individual custodian in the custodian data store 320, so that the delivery handoff system 202 may intelligently select a particular bicycle courier for fulfilling a request and may provide an accurate estimate of a delivery time. In some embodiments, a dispatcher of the bicycle courier may be tracked as a general custodian in the custodian data store 320, and may provide a particular service level agreement (e.g., any delivery made between any two points within a given geographical area within a predetermined amount of time) for the custodian recruiting engine 314 to predict estimated delivery times before a particular courier is assigned as a custodian. The third boost selection interface button 711 indicates that, for the third boost selection, a fee of $10 would be assessed by the payment processing engine 304. This higher amount may reflect the fee charged by the professional bicycle courier, and may be split between the bicycle courier and the delivery handoff system 202. As illustrated, the third boost option provides a much faster delivery than the previous options, but the price of choosing the option is higher.

A fourth boost option description 712 illustrates the use of a taxi as a potential custodian. As with the bicycle courier, a taxi may be tracked as an individual custodian in the custodian data store 320, or the dispatcher of the taxi service may be tracked as a general custodian in the custodian data store 320. When operating as a custodian, the taxi may be directed by the delivery handoff system 202 to a present location of a previous package custodian, may accept handoff of the package, and then may handoff the package to a subsequent custodian after being directed to the subsequent custodian by the delivery handoff system 202. This is distinct from traditional taxi dispatching services, which merely direct a taxi to a fixed location where a person is waiting for a taxi. The fourth boost selection interface button 713 indicates that, for the fourth boost selection, a fee of $20 would be assessed by the payment processing engine 304. This fee may be used to compensate the taxi for the estimated meter charge between the location of the previous custodian and the location of the subsequent custodian, and may be shared with the delivery handoff system 202. As illustrated, the fourth boost option provides the fastest delivery, but also at the highest cost.

As stated above, these options are exemplary only, and should not be seen as limiting. For example, in some embodiments, a single option may include more than one type of custodian, such as an individual and a dispatched courier, or more than one type of dispatched courier. The illustrated selection of options is merely exemplary, as well. In some embodiments, the custodian recruiting engine 314 may provide a list of all valid custodians, and the interface may allow the receiver 218 to browse and choose one or more intermediate custodians from the comprehensive list, instead of automatically selecting a predetermined set of optimal custodians.

FIG. 8 illustrates one embodiment of a communications interface presented by the client device 602 according to various aspects of the present disclosure. The illustrated example shows a case where the receiver 218 actuated the third boost selection interface button 711 to select the bicycle messenger custodian, and subsequently selected the communication interface button 702 to communicate with the custodians. In some embodiments, the communications interface may be launched in other ways, such as directly from the package folder interface illustrated in FIG. 602, in response to receiving a notification of a new message from the delivery handoff system 202, and/or the like.

The communications interface includes a back interface button 802 to return to a previous interface screen, a package name 803 to help identify the shown communication, and an input area for the receiver 218 to send messages to the other participants in the communication channel. As illustrated, previous messages 804 were exchanged between the receiver 218 and the original custodian. Once the package was handed off from the original custodian to the bicycle messenger custodian, current messages 806 were exchanged between the receiver 218 and the bicycle messenger custodian. As shown, the bicycle messenger custodian (accessing a similar interface) may refer to the previous messages sent between the receiver 218 and the original custodian.

Though embodiments in which a discrete sender 204 and receiver 218 are included in the chain of custody of a package are primarily described above, in some embodiments, a discrete receiver 218 or final destination may not be necessary. In such embodiments, the delivery handoff system 202 may be used to track a current custodian of a package, and to track future custodians to whom the package is handed off using the delivery handoff system 202. A current custodian may be guided to future custodians in such an embodiment, but a final custodian need never be specified. This may be useful for tracking lost packages, in that if a package goes missing, the current custodian would be the custodian with which the search for the package should begin.

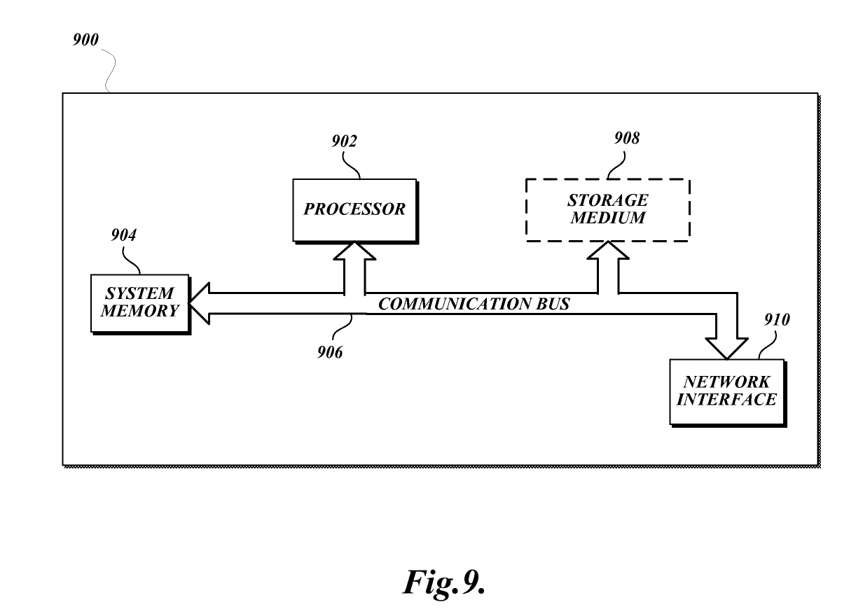

FIG. 9 illustrates aspects of an exemplary computing device 900 appropriate for use with embodiments of the present disclosure. While FIG. 9 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 900 may be any one of any number of currently available or yet to be developed devices.

In its most basic configuration, the computing device 900 includes at least one processor 902 and a system memory 904 connected by a communication bus 906. Depending on the exact configuration and type of device, the system memory 904 may be volatile or nonvolatile memory, such as read only memory (“ROM”), random access memory (“RAM”), EEPROM, flash memory, or similar memory technology. Those of ordinary skill in the art and others will recognize that system memory 904 typically stores data and/or program modules that are immediately accessible to and/or currently being operated on by the processor 902. In this regard, the processor 902 may serve as a computational center of the computing device 900 by supporting the execution of instructions.

As further illustrated in FIG. 9, the computing device 900 may include a network interface 910 comprising one or more components for communicating with other devices over a network. Embodiments of the present disclosure may access basic services that utilize the network interface 910 to perform communications using common network protocols. The network interface 910 may also include a wireless network interface configured to communicate via one or more wireless communication protocols, such as WiFi, 2G, 3G, LTE, WiMAX, Bluetooth, and/or the like.

In the exemplary embodiment depicted in FIG. 9, the computing device 900 also includes a storage medium 908. However, services may be accessed using a computing device that does not include means for persisting data to a local storage medium. Therefore, the storage medium 908 depicted in FIG. 9 is represented with a dashed line to indicate that the storage medium 908 is optional. In any event, the storage medium 908 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 904 and storage medium 908 depicted in FIG. 9 are merely examples of computer-readable media.

Suitable implementations of computing devices that include a processor 902, system memory 904, communication bus 906, storage medium 908, and network interface 910 are known and commercially available. For ease of illustration and because it is not important for an understanding of the claimed subject matter, FIG. 9 does not show some of the typical components of many computing devices. In this regard, the computing device 900 may include input devices, such as a keyboard, keypad, mouse, microphone, touch input device, touch screen, tablet, and/or the like. Such input devices may be coupled to the computing device 900 by wired or wireless connections including RF, infrared, serial, parallel, Bluetooth, USB, or other suitable connections protocols using wireless or physical connections. Similarly, the computing device 900 may also include output devices such as a display, speakers, printer, etc. Since these devices are well known in the art, they are not illustrated or described further herein.

As will be appreciated by one skilled in the art, the specific routines described above in the flowcharts may represent one or more of any number of processing strategies such as event-driven, interrupt-driven, multi-tasking, multi-threading, and the like. As such, various acts or functions illustrated may be performed in the sequence illustrated, in parallel, or in some cases omitted. Likewise, the order of processing is not necessarily required to achieve the features and advantages, but is provided for ease of illustration and description. Although not explicitly illustrated, one or more of the illustrated acts or functions may be repeatedly performed depending on the particular strategy being used. Further, these FIGURES may graphically represent code to be programmed into a computer readable storage medium associated with a computing device.

While illustrative embodiments have been illustrated and described, it will be appreciated that various changes can be made therein without departing from the spirit and scope of the disclosure.

The embodiments of the invention in which an exclusive property or privilege is claimed are defined as follows:

1. A delivery handoff system for managing delivery of packages, the system comprising:
at least one processor; and
a computer-readable medium having components executable by the at least one processor stored thereon, the components including:
a package routing engine configured to:
create a package record in a package data store, wherein the package record is associated with:
a custodian record associated with a current custodian of a package;
a custodian record associated with a next custodian of the package; and
a custodian record associated with a final custodian of the package,
wherein each custodian record includes an identifier of a handoff mobile device associated with the associated custodian; and
wherein the package routing engine is further configured to transmit a direction to the handoff mobile device associated with the current custodian to direct the current custodian toward at least the next custodian; and
a communication engine configured to:
establish a communication channel between the handoff mobile device of the final custodian and at least the handoff mobile device of the current custodian.

2. The system of claim 1, wherein the components further include:
a handoff processing engine configured to:
verify a handoff between the current custodian and the next custodian; and
update the package record to indicate that the handoff has occurred.

4. The system of claim 1, wherein the package routing engine is further configured to:
determine a location of a handoff mobile device associated with the final custodian; and
transmit a direction to a handoff mobile device associated with a custodian of the package to direct the custodian toward the final custodian.

5. The system of claim 1, wherein the components further include:
a custodian recruiting engine configured to:
store, in a custodian data store, at least the custodian record associated with the current custodian, the custodian record associated with the next custodian, and the custodian record associated with the final custodian.

6. The system of claim 5, wherein the custodian recruiting engine is further configured to:
create a new custodian record in the custodian data store in response to receiving a request to be added as a new custodian.

7. The system of claim 5, wherein the custodian recruiting engine is further configured to:
retrieve, from the custodian data store, one or more custodian records associated with custodians that satisfy predetermined criteria with respect to a package in possession of a current custodian; and
receive, from the handoff mobile device associated with the final custodian, a selection of at least one of the one or more custodian records to be added as an additional custodian.

8. The system of claim 7, wherein the custodian recruiting engine is further configured to update the package record with the at least one selected custodian record as an additional custodian.

9. The system of claim 8, wherein the package routing engine is further configured to transmit a direction to a handoff mobile device associated with the current custodian to redirect the current custodian to the additional custodian.

10. The system of claim 2, wherein the communication engine is further configured to add the handoff mobile device of the next custodian to the communication channel between the handoff mobile device of the current custodian and the handoff mobile device of the final custodian.

11. The system of claim 10, wherein the communication engine is further configured to provide a record of previous communication over the communication channel to the handoff mobile device of the next custodian.

12. The system of claim 10, wherein the communication engine is further configured to remove the handoff mobile device of the current custodian from the communication channel.

13. A computer-implemented method of managing delivery of a package, the method comprising:
storing a package record in a package data store, wherein the package record is associated with a current custodian of the package and a final custodian of the package;
transmitting location information of the final custodian to a handoff mobile device associated with the current custodian to guide the current custodian toward the final custodian;
receiving a selection of an additional custodian for the package;
associating the package record with the additional custodian; and
transmitting location information of the additional custodian to the handoff mobile device associated with the current custodian to guide the current custodian toward the additional custodian instead of the final custodian.

14. The computer-implemented method of claim 13, further comprising:
establishing a secure communication channel between the current custodian and the final custodian;
adding the additional custodian to the secure communication channel; and
transmitting to the additional custodian communication sent via the secure communication channel before the additional custodian was added.

15. The computer-implemented method of claim 13, further comprising verifying a handoff of the package from the current custodian to the additional custodian.

16. The computer-implemented method of claim 13, wherein receiving a selection of an additional custodian for the package includes receiving a selection of a plurality of additional custodians for the package, and wherein the method further comprises associating the plurality of additional custodians with the package record.

17. The computer-implemented method of claim 16, wherein transmitting location information of the additional custodian includes:
selecting an additional custodian from the plurality of additional custodians; and
transmitting location information of the selected additional custodian to the handoff mobile device associated with the current custodian.

18. The computer-implemented method of claim 17, wherein selecting an additional custodian includes:
determining a location of the current custodian;
determining a location of each additional custodian of the plurality of additional custodians; and
selecting an additional custodian based on a comparison of the location of the current custodian and each of the plurality of additional custodians.

19. The computer-implemented method of claim 17, wherein selecting an additional custodian includes:
determining a predicted future location of the current custodian;
determining a predicted future location of each additional custodian of the plurality of additional custodians; and
selecting an additional custodian based on a comparison of the predicted future location of the current custodian and of each of the plurality of additional custodians.

20. The computer-implemented method of claim 13, wherein the additional custodian includes a dispatching service and a dispatched custodian, and wherein the method further comprises obtaining location information of the dispatched custodian from the dispatching service.

21. A computer-readable medium having computer-executable instructions stored thereon that, if executed by one or more processors of a computing device, cause the computing device to perform actions for managing delivery of a package, the actions comprising:
storing a package record in a package data store, wherein the package record is associated with a current custodian of the package and a final custodian of the package;
transmitting location information of the final custodian to a handoff mobile device associated with the current custodian to guide the current custodian toward the final custodian;
receiving a selection of an additional custodian for the package;
associating the package record with the additional custodian; and
transmitting location information of the additional custodian to the handoff mobile device associated with the current custodian to guide the current custodian toward the additional custodian instead of the final custodian.

22. The computer-readable medium of claim 21, wherein the actions further comprise:
establishing a secure communication channel between the current custodian and the final custodian;
adding the additional custodian to the secure communication channel; and
transmitting to the additional custodian communication sent via the secure communication channel before the additional custodian was added.

23. The computer-readable medium of claim 21, wherein the actions further comprise verifying a handoff of the package from the current custodian to the additional custodian.

24. The computer-readable medium of claim 21, wherein receiving a selection of an additional custodian for the package includes receiving a selection of a plurality of additional custodians for the package, and wherein the actions further comprise associating the plurality of additional custodians with the package record.

25. The computer-readable medium of claim 24, wherein transmitting location information of the additional custodian includes:
selecting an additional custodian from the plurality of additional custodians; and
transmitting location information of the selected additional custodian to the handoff mobile device associated with the current custodian.

26. The computer-readable medium of claim 25, wherein selecting an additional custodian includes:
determining a location of the current custodian;
determining a location of each additional custodian of the plurality of additional custodians; and
selecting an additional custodian based on a comparison of the location of the current custodian and each of the plurality of additional custodians.

27. The computer-readable medium of claim 25, wherein selecting an additional custodian includes:
determining a predicted future location of the current custodian;
determining a predicted future location of each additional custodian of the plurality of additional custodians; and
selecting an additional custodian based on a comparison of the predicted future location of the current custodian and of each of the plurality of additional custodians.

28. The computer-readable medium of claim 21, wherein the additional custodian includes a dispatching service and a dispatched custodian, and wherein the actions further comprise obtaining location information of the dispatched custodian from the dispatching service.
